(19) United States
(12) Patent Application Publication
(10) Pub. No.: US 2025/0146314 A1
(43) Pub. Date: May 8, 2025

(54) MECHANICAL DIRECTION CHANGE STRUCTURE FOR POOL CLEANER, AND POOL CLEANER

(71) Applicant: WYBOTICS CO., LTD, Tianjin (CN)

(72) Inventors: Pu CEN, Tianjin (CN); Huchen GONG, Tianjin (CN)

(73) Assignee: WYBOTICS CO., LTD, Tianjin (CN)

(21) Appl. No.: 18/837,899

(22) PCT Filed: Aug. 14, 2023
(86) PCT No.: PCT/CN2023/112934

§ 371 Date: Aug. 13, 2024

(30) Foreign Application Priority Data
Aug. 2, 2022 (CN) 202210922419.7
Nov. 14, 2022 (CN) 202211423101.0

(51) Int. Cl. E04H 4/16; B63G 8/00

(52) U.S. Cl. CPC E04H 4/1654; B63G 8/001; B63G 2008/002

(57) ABSTRACT

A mechanical direction change structure for a pool cleaner, and a pool cleaner are provided. The mechanical direction change structure includes a rotating element, at least one stopping device, and at least one swinging element, where the rotating element includes a water inlet, a middle flow channel, and a rotating water outlet that are sequentially communicated for water to flow through; the rotating element is rotatable around a rotation axis and provided on a pool cleaner body; the stopping device is rotatable relative to the pool cleaner body; the swinging element is swingable around a swinging axis; when a pool cleaner is moving, the stopping device abuts with the swinging element, and the rotating water outlet is positioned in a first propelling direction; and when the pool cleaner is obstructed, the stopping device detaches from the swinging element, and the rotating water outlet rotates towards a second propelling direction.

### CROSS-REFERENCE TO THE RELATED APPLICATIONS

This application is the national phase entry of International Application No. PCT/CN2023/112934, filed on Aug. 14, 2023, which is based upon and claims priority to Chinese Patent Application No. 202210922419.7, filed on Aug. 2, 2022; and Chinese Patent Application No. 202211423101.0, filed on Nov. 14, 2022, the entire contents of which are incorporated herein by reference.

### TECHNICAL FIELD

The present disclosure belongs to the technical field of pool cleaning, and in particular relates to a mechanical direction change structure for a pool cleaner, and a pool cleaner.

### BACKGROUND

When a pool cleaner encounters a wall or an obstacle during a cleaning process in the pool, it needs to change its direction. The existing automatic pool cleaners generally adopt the following turnaround control mechanisms.

### 1. Fixed Turnaround Time

The turnaround time (traveling from one side of the pool wall to the opposite side) is controlled through electrical means (writing a fixed turnaround time in the control program of the pool cleaner controller) or mechanical means (as described in Chinese Patent Application CN102828625B), and the turnaround time is fixed once set. The fixed turnaround time mechanism has at least the following issues. The fixed turnaround time inevitably requires a constant moving speed and direction. However, the moving speed and direction are inevitably affected in case of an obstacle or turbulence (such as one caused by the filler, water outlet, or swimmers), leading to premature turnaround, delayed turnaround, and even failure to turnaround due to the obstruction of pool wall. In addition, the fixed turnaround control mechanism cannot recognize whether the pool cleaner encounters a wall or an obstacle and make the pool cleaner return or turn. Once the pool cleaner encounters a wall or an obstacle, the pool cleaner must wait until the set time cycle ends before it turns, resulting in significant efficiency loss.

### 2. The Use of the Sensor to Detect Pool Wall/Obstacle

In order to address the problems of the fixed turnaround time mechanism, some pool cleaners in the prior art use an electronic component for wall detection. They rely on the sensitivity of the electronic component, have high requirements for the working environment, have low detection reliability, and involve a lot of computational work in the transmission and processing of sensing signals. In addition, there are high performance requirements on the pool cleaner controller, high power consumption, significant impact from the underwater environment, complex structure, and high cost.

### 3. Abutment/Detachment Between a Swinging Element Restored After Being Blocked (by a Pool Wall/Obstacle) and a Stopping Element

In order to address the problems of the above sensor, prior art provides a wall-touching mechanical direction change mechanism. The direction change control of the wall-touching mechanical direction change mechanism does not use any sensors. Driven by a rotating element, a resistance plate intermittently abuts with/detaches from a stopping element. The abutment causes the pool cleaner to move, and the detachment causes the pool cleaner to change its direction. To ensure a large-volume buoyancy-based resistance plate, especially for a large-volume end far from the swinging axis of itself, the large-volume resistance plate rotates with the rotating element. However, the resistance plate is prone to detaching from the stopping element in case of an excessive swinging angle. Meanwhile, the rotation of the swinging plate with the rotating element results in a large resistance, which increases energy consumption, and especially reduces endurance of the power supply that uses a battery. Besides, when the large-volume swinging plate rotates, it is subjected to a significant water reaction torque, which seriously affects the rotational connection between the rotating element and the shell of the pool cleaner. The significant torque can also increase the uncertainty in the moving direction, thereby hindering path planning.

### SUMMARY

The present disclosure aims to solve the problems of three direction change mechanisms, namely the fixed turnaround time, the pool wall detection sensor, and the abutment/detachment between the swinging element restored after being blocked (by a pool wall/obstacle) and the stopping element. For this purpose, a first aspect of the present disclosure provides a mechanical direction change structure for a pool cleaner, including:
a rotating element, including a water inlet, a middle flow channel, and a rotating water outlet that are sequentially communicated for water to flow through, where the rotating element is rotatable around a rotation axis and provided on a pool cleaner body;
at least one stopping device, rotatable relative to the pool cleaner body; and
at least one swinging element, swingable around a swinging axis and provided on the pool cleaner body;
where, when the pool cleaner is moving, the stopping device abuts with the swinging element, and the rotating water outlet is positioned in a first propelling direction; and
when the pool cleaner is obstructed, the stopping device detaches from the swinging element, and the rotating water outlet rotates towards a second propelling direction.

Further, when the pool cleaner is obstructed,
the rotating element rotates to a position where another stopping device abuts with the swinging element; or
the rotating element rotates to a position where the stopping device abuts with another swinging element.

Further, when the pool cleaner is obstructed, the stopping device is able to overcome the abutment with the swinging element, due to a rotational force of the rotating element.

Further, the stopping device is fixed to the rotating element or formed on the rotating element.

Further, in a stationary state underwater, the swinging element is able to be restored to remain vertical.

Further, the swinging element is restored by a buoyancy.

Further, the swinging element is restored by a counterweight fixed below the swinging axis.

Further, the swinging element is provided with an end with a density less than a density of water; and/or,
the swinging element is provided with a hollow end.

Further, an elastic restoring element is provided between the swinging element and the pool cleaner body.

Further, when the pool cleaner is obstructed, the rotating element drives the stopping device to rotate, making the swinging element swing an angle towards an obstructed side and detach from the stopping device, such that:
as the rotating element rotates, another stopping device abuts with the swinging element; or
as the rotating element rotates, the stopping device abuts with another swinging element; and
the rotating water outlet points towards the second propelling direction.

Further, the swinging element is able to be blocked by the stopping device; and
a rotational torque of the rotating element is greater than a restoring torque of the swinging element, such that the rotating element is able to overcome the blocking of the swinging element, causing a part of the swinging element located above the swinging axis to swing towards the obstructed side.

Further, when the pool cleaner is obstructed, the rotating element rotates to a position where another stopping device abuts with the swinging element; and
there are two stopping devices; the two stopping devices are symmetrically distributed on opposite sides of the rotation axis and are fixed to the rotating element; and alternatively, the two stopping devices are integrally formed.

Further, there is one swinging element; and an angle between the swinging axis and the first propelling direction and an angle between the swinging axis and the second propelling direction are close to 90°.

Further, the swinging element extends radially along the swinging axis to form a swinging portion and extends along the swinging axis to form an abutting assembly; the swinging portion is located above the swinging axis, and the abutting assembly is located on a side facing the stopping device; and the abutting assembly is able to abut with the stopping device.

Further, the two stopping devices each include a first stopping element and a second stopping element that are arranged above and below; and the first stopping element and the second stopping element maintain a clearance in a direction of the rotation axis for the stopping device to pass through;
the abutting assembly is provided with a first abutting portion for abutting with the first stopping element and a second abutting portion for abutting with the second stopping element;
when the pool cleaner is moving, the first abutting portion abuts with the first stopping element; and
the second abutting portion abuts with the second stopping element.

Further, the first abutting portion faces an opposite direction of a rotation direction of the rotating element, and a side of the first stopping element facing the rotation direction of the rotating element forms an upper stopping surface that abuts with the first abutting portion.

Further, the second abutting portion faces the opposite direction of the rotation direction of the rotating element, and a side of the second stopping element facing the rotation direction of the rotating element forms a lower stopping surface that abuts with the second abutting portion.

Further, the first abutting portion, the upper stopping surface, the second abutting portion, and the lower stopping surface are all flat.

Further, during restoration, an angle between the first abutting portion and a plane where a traveling wheel is located is equal to an angle between the second abutting portion and the plane where the traveling wheel is located.

Further, a free end of the swinging portion is a flat structure that extends along a surface vertical to a moving direction.

Further, the mechanical direction change structure further includes a top shell; the top shell is located outside the rotating element and forms a diversion chamber; the top shell is provided with water outlets that are communicated with the diversion chamber; the water outlets are respectively located in propelling directions pointed at by the rotating water outlet; and the swinging axis does not coincide with a connecting line between any water outlets.

Further, there are three or more water outlets; and the traveling wheel of the pool cleaner is a universal wheel.

Further, there are two water outlets symmetrically arranged on two sides of the rotation axis.

Further, the water outlets extend in a direction vertical to the rotation axis.

Further, the swinging axis is parallel or approximately parallel to an axis of the traveling wheel of the pool cleaner.

Further, the top shell is provided with a mounting hole; and the rotating element passes through the mounting hole and is fixed to the stopping device.

Further, a bearing is provided in the mounting hole; and the rotating element and/or the stopping device are rotatably provided on the top shell through the bearing.

Further, the mechanical direction change structure further includes a power assembly for causing the water to flow.

Further, an impeller provided in the flow channel is a centrifugal impeller; and an axis of the impeller is coaxial with a direction of the water inlet of the flow channel.

Further, the flow channel is a snail shell structure.

A second aspect of the present disclosure provides a pool cleaner, including:
the mechanical direction change structure according to any one of the above paragraphs;
a main water inlet, a main flow channel, and a main water outlet that are sequentially communicated, where the main water outlet is communicated with the water inlet;
the power assembly, configured to cause the water to flow sequentially along the main water inlet, the main flow channel, the main water outlet, the water inlet, the flow channel, and the rotating water outlet; and
a filter structure, provided between the main flow channel and the water inlet to block and store a dirt in the water.

Further, when the pool cleaner is obstructed, the pool cleaner comes to a standstill or decelerates to a speed close to 0.

The present disclosure achieves the following beneficial effects:

When the pool cleaner is moving, the swinging element is subjected to the combined action of the water resistance and the rotational force of the rotating element, and the stopping device abuts with the swinging element. The stopping device and the rotating element stop rotating around the rotation axis. The rotating water outlet formed on the rotating element is positioned in the first propelling direction. The pool cleaner is driven by the reaction force of the water flow from the rotating water outlet, and moves in the first direction.

When the pool cleaner is obstructed, the water resistance on the swinging element decreases to less than the rotational force, causing the stopping device and the swinging element to overcome the abutment state. Under these unequal forces, the stopping device detaches from the swinging element and rotates due to the rotational force. The stopping device rotates until the rotating water outlet points towards the second propelling direction, and the stopping device is repositioned. Under the reaction force of the water flow from the rotating water outlet, the pool cleaner moves in the second direction, thereby achieving the direction change purpose.

The direction change logic is as follows. When the pool cleaner is obstructed, its traveling speed decreases, and the water resistance on the swinging element decreases to less than the rotational force of the rotating element. The abutment state (force balance) is disrupted, and the stopping device and the swinging element overcome the abutment state. The abutment/detachment is completely triggered by the obstruction condition. The release of the abutment is triggered only when the speed of the pool cleaner decreases to reach the above condition (the water resistance on the swinging element is less than the rotational force of the rotating element), thereby achieving reliable direction change.

Based on the above direction change logic, the swinging element can only swing relative to the pool cleaner body. Thus, the swinging element can reliably abut with the stopping device, avoiding them from detaching during abutment. The design avoids an excessive water resistance on the swinging element rotating relative to the pool cleaner body. An excessive resistance will consume too much energy (especially reduce the endurance when a battery serves as a source of energy). In addition, the design avoids an excessive water reaction torque, thereby avoiding affecting the rotational connection with the pool cleaner body. The design also avoids the eccentric effect of an excessive torque changing with the rotation position. The change will cause uncertainty in the moving direction of the pool cleaner, making the pool cleaner unable to travel along the desired path. In the present disclosure, the swinging element swings rather than rotates relative to the pool cleaner body, and its eccentric configuration enables the controllable eccentric effect on the pool cleaner (the circumferential position of the swinging axis is fixed, and the eccentric effect always points towards the swinging axis. To offset or partially offset the eccentric effect, a counterweight can be added to a fixed position on the other side of the eccentricity to balance or partially balance the eccentric effect. Obviously, the swinging element can rotate relative to the pool cleaner body, as the direction of the eccentric effect is uncertain, so it is not realistic to compensate for it). The impact of the eccentric effect on the moving direction of the pool cleaner is relatively fixed, making it easy for the pool cleaner to travel along the desired (planned) path.

The present disclosure avoids the following problems existing in the prior art. The fixed turnaround time mechanism cannot achieve a flexible direction change when an obstacle appears. The sensor, electronic control component, and control program face the risk of failure due to errors. When the swinging element rotates relative to the pool cleaner body, it cannot achieve the desired stable abutment state, causing problems such as easy detachment, high energy consumption, and inability to move along the desired path.

### BRIEF DESCRIPTION OF THE DRAWINGS

FIG. 1 is a three-dimensional structural diagram of a pool cleaner from a first perspective according to an embodiment;

FIG. 2 is a three-dimensional structural diagram of the pool cleaner, shown in FIG. 1, from a second perspective, where a main water inlet is shown;

FIG. 3 is a top view of the pool cleaner shown in FIG. 1;

FIG. 4 is a sectional view along A-A shown in FIG. 3;

FIG. 5A shows that the pool cleaner is stationary on a cleaning surface and a rotating element has not started to rotate, where a swinging element is in a restored state, and a stopping device detaches from the swinging element, allowing the rotating element to rotate freely; FIG. 5B is a top view of FIG. 5A; and FIG. 5C is a sectional view along A-A shown in FIG. 5B;

FIG. 6A shows that the rotating element rotates until the start of a pre-swinging (triggered by the first stopping element) action, where the swinging element is in the restored state; FIG. 6B is a top view of FIG. 6A; and FIG. 6C is a sectional view along A-A shown in FIG. 6B;

FIG. 7A shows that the rotating element rotates until the end of the pre-swinging (triggered by the first stopping element) action, where the pre-swinging action of the swinging element (in a rotation direction of the rotating element) an angle ends; FIG. 7B is a top view of FIG. 7A; and FIG. 7C is a sectional view along A-A shown in FIG. 7B;

FIG. 8A shows that the rotating element rotates until the start of the abutment between a second stopping element and the swinging element, where the swinging element is restored a small angle from a pre-swinging angle shown in FIG. 7A; FIG. 8B is a top view of FIG. 8A; and FIG. 8C is a sectional view along A-A shown in FIG. 8B;

FIG. 9A shows that the rotating element rotates and the second stopping element abuts with the swinging element, a rotating water outlet is positioned in a first propelling direction, and the pool cleaner (generally) moves in an opposite direction of the first propelling direction; FIG. 9B is a top view of FIG. 9A; and FIG. 9C is a sectional view along A-A shown in FIG. 9B;

FIG. 10A shows that one side of the pool cleaner is obstructed, the swinging element is restored an angle to the restored state (not fully restored), the second stopping element detaches from the swinging element, and the swinging element pre-swings an angle due to a rotational force of the second stopping element; FIG. 10B is a top view of FIG. 10A; and FIG. 10C is a sectional view along A-A shown in FIG. 10B;

FIG. 11A shows that the second stopping element completely detaches from the swinging element, and the pre-swinging action of the swinging element caused by the second stopping element ends; FIG. 11B is a top view of FIG. 11A; and FIG. 11C is a sectional view along A-A shown in FIG. 11B;

FIG. 12A shows that the first stopping element starts to abut with the swinging element; FIG. 12B is a top view of FIG. 12A; and FIG. 12C is a sectional view along A-A shown in FIG. 12B;

FIG. 13A shows that the first stopping element abuts with the swinging element, the rotating water outlet is positioned in a second propelling direction, and the pool cleaner (generally) moves in an opposite direction of the second propelling direction; FIG. 13B is a top view of FIG. 13A; and FIG. 13C is a sectional view along A-A shown in FIG. 13B;

FIG. 14 is a three-dimensional structural diagram of the pool cleaner from the first perspective according to an embodiment;

FIG. 15 shows that the first stopping element is about to act on the swinging element so as to enable pre-swinging according to an embodiment;

FIG. 16 is a schematic diagram showing a water flow inside a mechanical direction change structure according to an embodiment;

FIG. 17 shows that the second stopping element changes from an abutment state to a pre-swinging state according to an embodiment;

FIG. 18 shows that the second stopping element acts on a second abutting portion and the swinging element pre-swings according to an embodiment;

FIG. 19 shows that the second stopping element and the second abutting portion detach from each other according to an embodiment;

FIG. 20 is a sectioned view showing that a first stopping element is in contact with a first abutting portion according to Embodiment 2 of the present disclosure;

FIG. 21 is a sectioned view showing that the first stopping element detaches from the first abutting portion according to Embodiment 2 of the present disclosure;

FIG. 22 is a structural diagram showing that the first stopping element is in contact with the first abutting portion according to Embodiment 2 of the present disclosure; and

FIG. 23 is a structural diagram showing that the first stopping element slides over the first abutting portion when it detaching from the first abutting portion according to Embodiment 2 of the present disclosure.

### REFERENCE NUMERALS

01. rotating element; 011. water inlet; 012. flow channel; and 013. rotating water outlet;
02. stopping device; 021. first stopping element; 0211. upper stopping surface; 022. second stopping element; and 0221. lower stopping surface;
03. swinging element; 031. swinging portion; 0311. end; 032. abutting assembly; 0321. first abutting portion; and 0322. second abutting portion;
041. first propelling direction; 042. second propelling direction; 043. rotation axis; 044. swinging axis; 045. swinging direction; and 046. rotation direction;
05. obstacle;
06. top shell; 061. diversion chamber; and 062. water outlet;
07. rotating element; and 071. bearing;
08. power assembly; 081. motor; and 082. impeller; and
090. pool cleaner body; 091. main water inlet; 092. main flow channel; 093. main water outlet; 094. filter structure; and 095. traveling wheel.

### DETAILED DESCRIPTION OF THE EMBODIMENTS

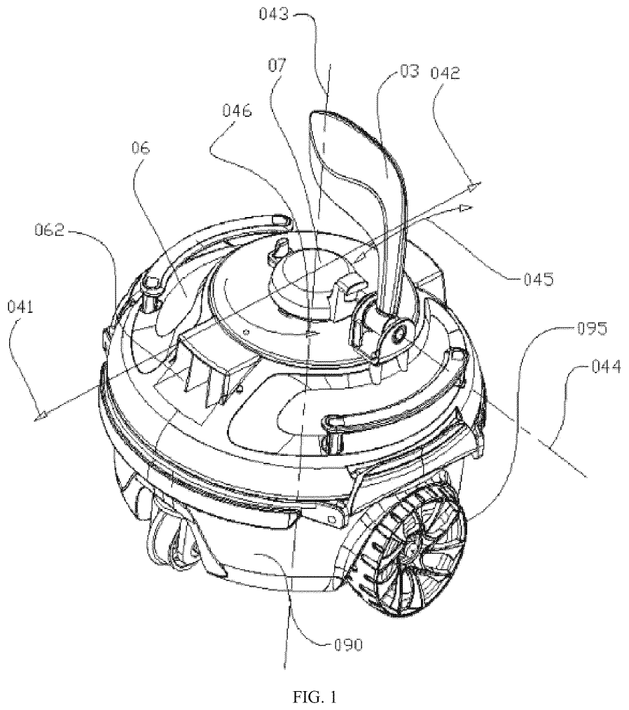

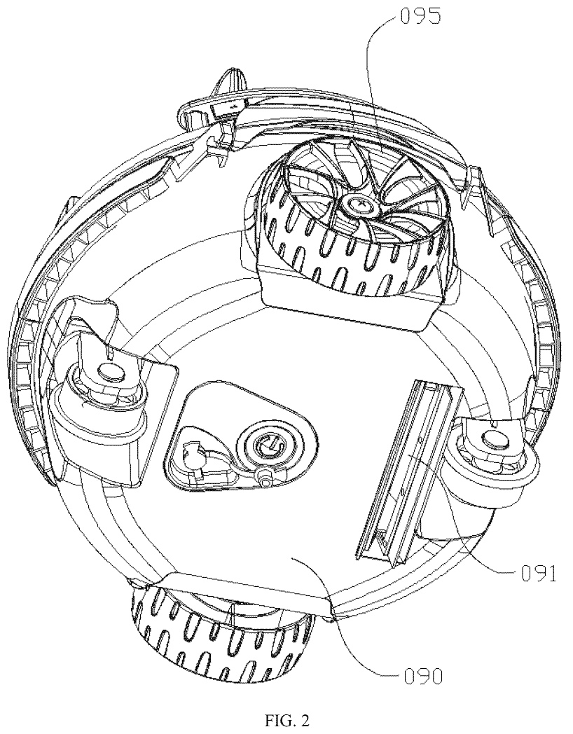

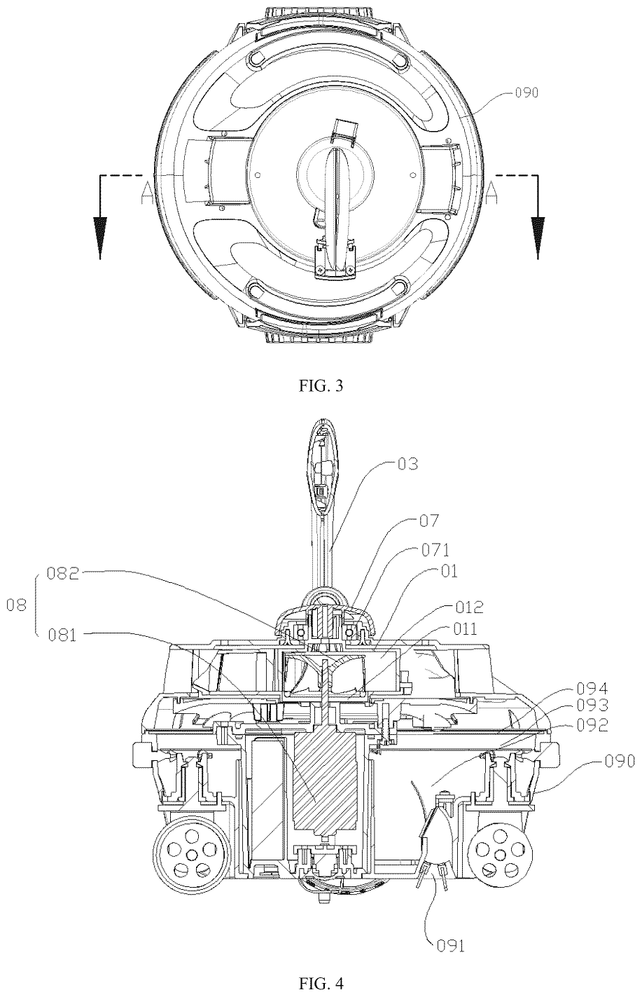

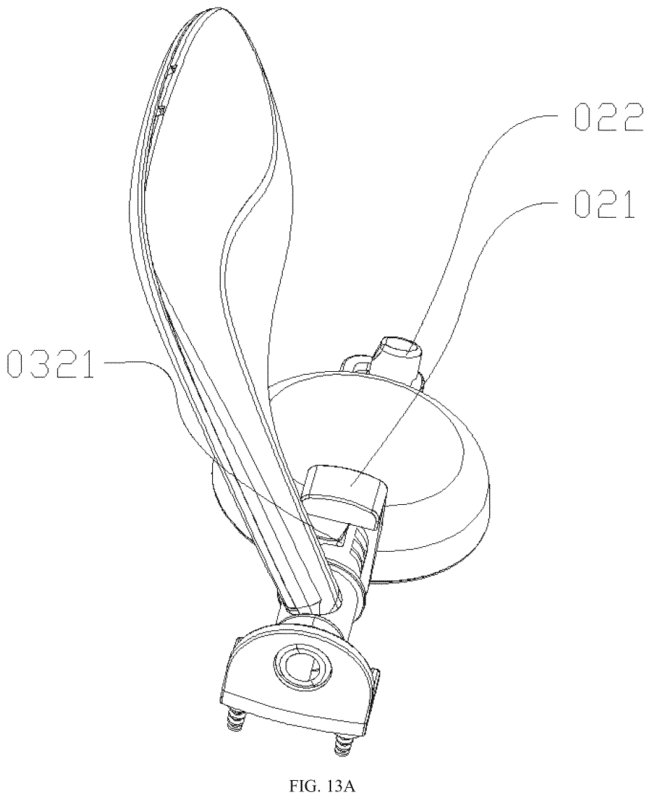

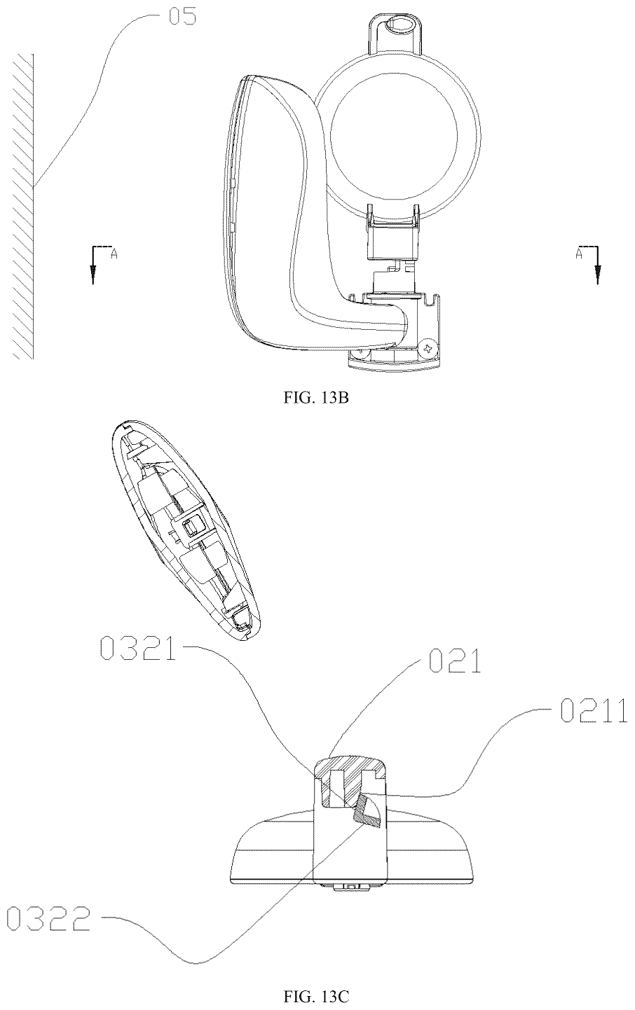

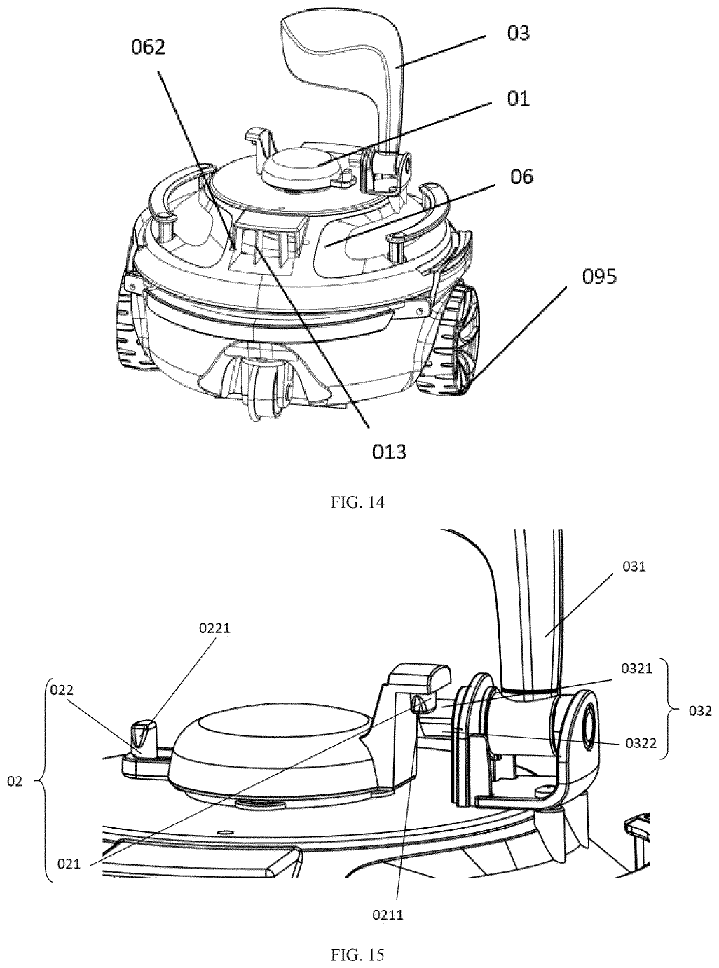

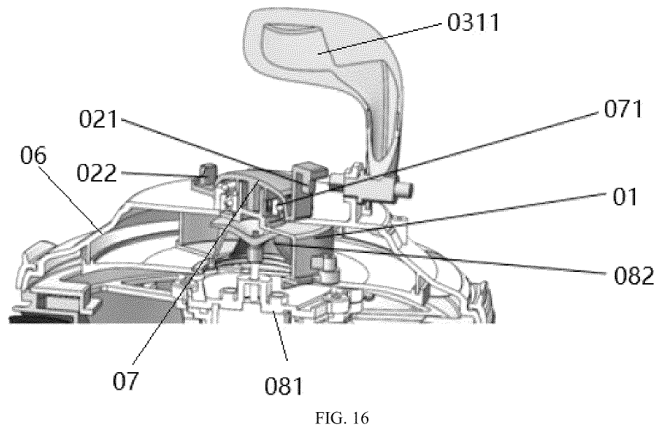

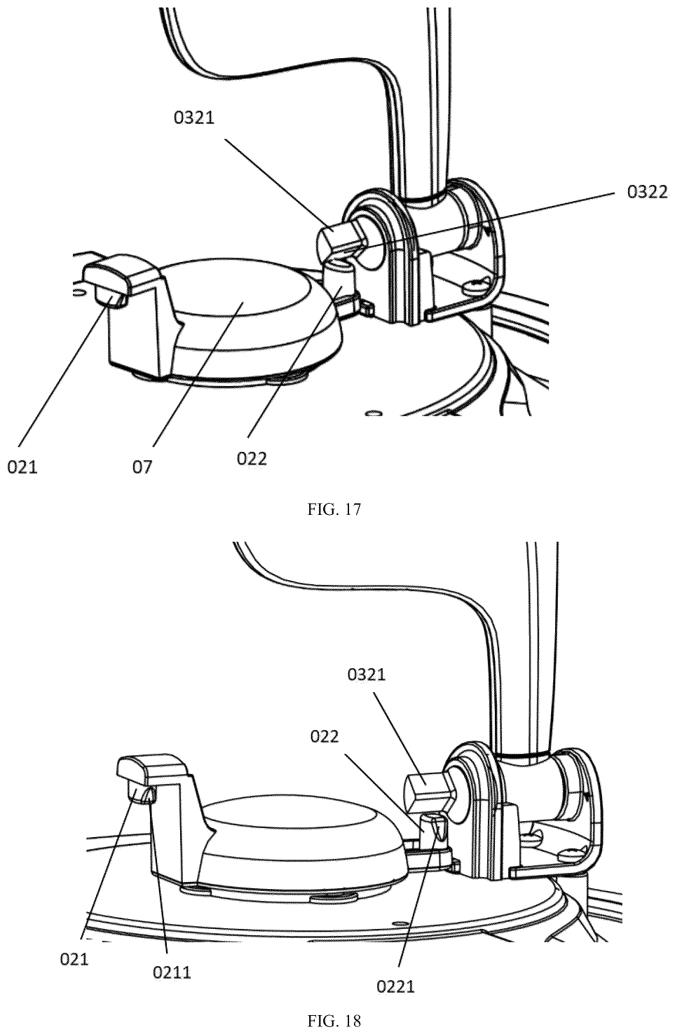

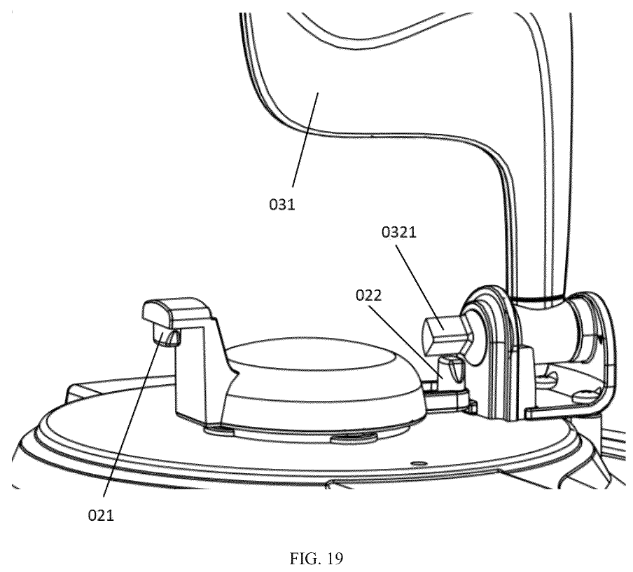

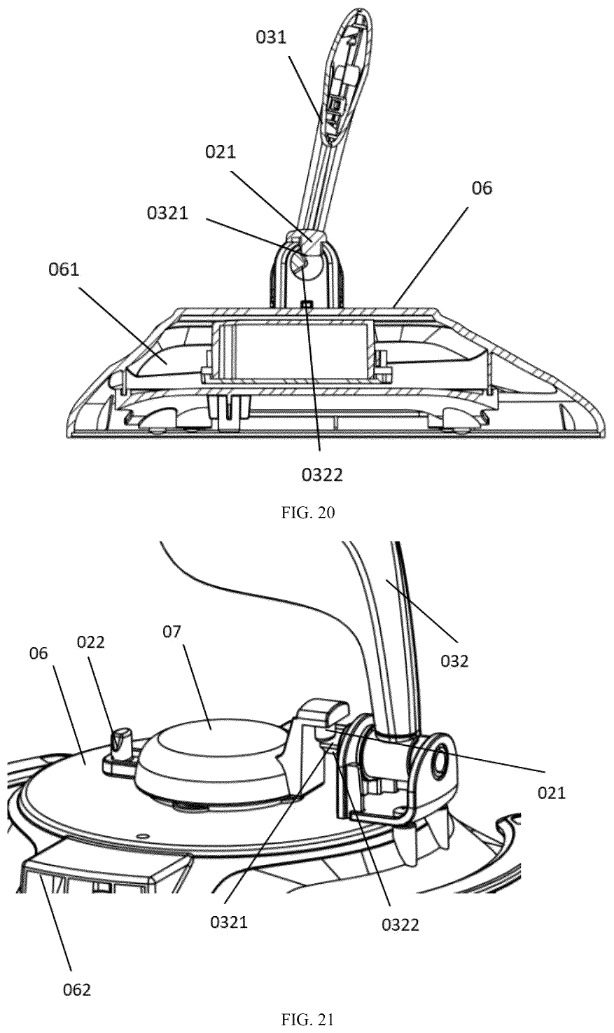

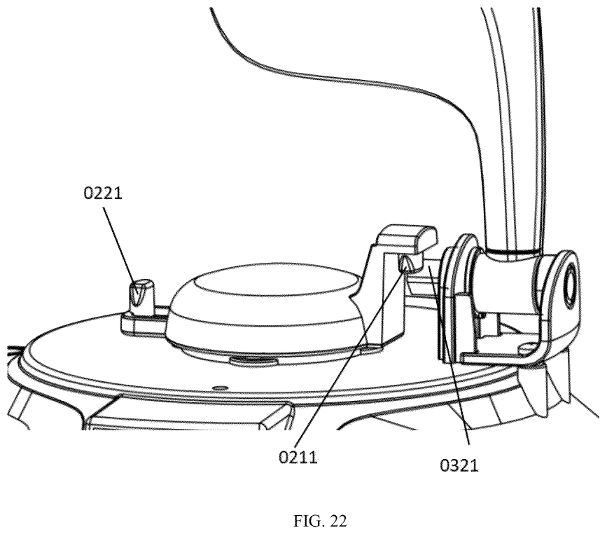

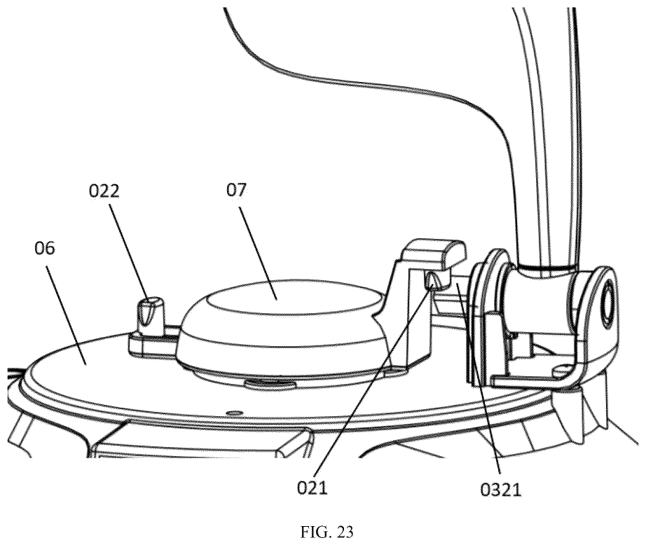

A first aspect of an embodiment of the present disclosure provides a mechanical direction change structure for a pool cleaner. As shown in FIGS. 1 to 4 and FIGS. 14 to 23, the mechanical direction change structure includes rotating element 01, at least one stopping device 02, and at least one swinging element 03. Driven by a water flow, the rotating element 01 and the stopping device 02 rotate around a rotation axis. The swinging element 03 swings according to A moving state of the pool cleaner (specifically, an end of the swinging element 03 far away from swinging axis 044 swings towards a rear of a moving direction). The moving state is logically determined by whether the pool cleaner is obstructed (obstacle 05). Therefore, it is reliable to “detect” the movement state of a pool cleaner body based on the swinging action of the swinging element 03.

When the pool cleaner is traveling, the swinging element 03 swings backwards to a position due to a water resistance. The swinging element can abut with the stopping device 02 that rotates to the position (due to a combined effect of a rotational force of the rotating element 01 and the water resistance on the swinging element 03, the stopping device 02 abuts with the swinging element 03). Rotating water outlet 013 is positioned in first propelling direction 041, and the pool cleaner moves in an opposite direction of the first propelling direction 041. If the pool cleaner is obstructed, the water flows from a water inlet of the rotating element 01, flows through middle flow channel 012, and flows out from the rotating water outlet 013. When the water flows along the path, it drives the rotating element 01 to rotate around rotation axis 043, thereby driving the stopping device 02 to rotate around the rotation axis 043. The power driving the rotation of the rotating element 01 comes from the water flow, so the filtered water discharged from the water outlet of the pool cleaner can be utilized. Therefore, the mechanical direction change structure can be easily applied to the pool cleaner without the need for additional power to drive the rotation of the rotating element 01, greatly simplifying the structure and reducing costs.

The swinging element 03 can only swing relative to the pool cleaner body around the swinging axis 044 (the swinging axis 044 can be an axis of a swinging shaft that is fixed to the pool cleaner body), but it cannot rotate. Thus, the swinging element 03 can reliably abut with the stopping device 02, avoiding them from detaching during abutment. The design avoids an excessive water resistance on the swinging element 03 rotating relative to the pool cleaner body. An excessive resistance will consume too much energy (especially reduce the endurance when a battery serves as a source of energy). In addition, the design avoids an excessive water reaction torque, thereby avoiding affecting the rotational connection with the pool cleaner body. The design also avoids the eccentric effect of an excessive torque changing with the rotation position. The change will cause uncertainty in the moving direction of the pool cleaner, making the pool cleaner unable to travel along the desired path. In the present disclosure, the swinging element 03 swings rather than rotates relative to the pool cleaner body 090, and its eccentric configuration enables the controllable eccentric effect on the pool cleaner (the circumferential position of the swinging axis 044 is fixed, and the eccentric effect always points towards the swinging axis 044. To offset or partially offset the eccentric effect, a counterweight can be added to a fixed position on the other side of the eccentricity to balance or partially balance the eccentric effect. Obviously, the swinging element 03 can rotate relative to the pool cleaner body 090, as the direction of the eccentric effect is uncertain, so it is not realistic to compensate for it). The impact of the eccentric effect on the moving direction of the pool cleaner is relatively fixed, making it easy for the pool cleaner to travel along the desired path.

If the blocking effect of the swinging element 03 is not considered, the rotating element 01 can continue to rotate around the rotation axis 043 due to the water flow. Especially, the water flow that causes the rotating element 01 to rotate is located in the water flow path of the pool cleaner, so the power drive of the pool cleaner can be directly used, simplifying the structure and improving operating efficiency.

In addition, swinging direction 045 of the swinging element is shown by the arrow in FIG. 1, and rotation direction 046 of the rotating element is shown in FIG. 1.

Based on this, the swinging element 03 can intermittently abut with and detach from the stopping device 02 according to the relative speed of water. In case of abutment, the rotating water outlet 013 is positioned in the first propelling direction 041, and the pool cleaner moves in the opposite direction of the first propelling direction 041. When the pool cleaner is obstructed, the stopping device 02 detaches from the swinging element 03. The rotating water outlet 013 rotates towards second propelling direction 042 and is ultimately positioned in the second propelling direction 042. Therefore, under the reaction force of the water flow from the rotating water outlet 013, the pool cleaner moves in an opposite direction of the second propelling direction 042.

In one of the ways in which the rotation of the rotating element 01 is driven, water inlet 011, the middle flow channel 012, and the rotating water outlet 013 are sequentially communicated with each other inside the rotating element 01 for the water flow to pass through. The rotating element 01 is rotatably provided on the pool cleaner body around the rotation axis 043. When the water flows along the water inlet 011, the flow channel 012, and the rotating water outlet 013, the rotating element 01 is driven to rotate through hydraulic coupling. The design features a simple structure and fully utilizes the water flow effect of the pool cleaner.

When the pool cleaner is obstructed, the rotating water outlet 013 is positioned in the second propelling direction 042, which can be achieved through the following two methods. In a method illustrated by the embodiment of the present disclosure, the rotating element 01 rotates to a position where another stopping device 02 abuts with the swinging element 03. In the other method, the rotating element 01 rotates to a position where the stopping device 02 abuts with another swinging element 03.

In addition, when the pool cleaner is obstructed, due to the rotational force of the rotating element 01, the stopping device 02 can overcome the abutment with the swinging element 03. Thus, the stopping device 02 and the swinging element 03 overcome the abutment state, and the rotating element 01 rotates due to the rotational force. In this way, the rotating element 01 rotates to the position where another stopping device 02 abuts with the swinging element 03. Alternatively, the rotating element 01 rotates to the position where the stopping device 02 abuts with another swinging element 03. In this way, the rotating water outlet 013 rotates from the first propelling direction 041 and is positioned in the second propelling direction 042, thereby changing the propelling direction.

It should also be noted that the stopping device 02 and the rotating element 01 can be independent components and can be fixed by a connecting element. Alternatively, the stopping device 02 can be integrated with the rotating element 01 and become part of the rotating element 01.

It should also be noted that in a stationary state underwater, the swinging element 03 can be restored to remain vertical. The swinging element 03 can always be subjected to a restoring force that causes it to swing vertically. Due to the restoring force and the rotational force of the stopping device 02, when the stopping device 02 abuts with the swinging element 03, the swinging element remains stable, and when the stopping device detaches from the swinging element, the swinging element can always be compressed.

In a way of forming the restoring force, the swinging element 03 is restored by a buoyancy. An extended arm with a buoyancy greater than gravity is provided on one side of the swinging axis 044. The buoyancy restoration method does not require the intervention of other parts and features a simple structure and reliable restoration.

In a way of restoring through buoyancy, the swinging element 03 is provided with end 0311 with a density less than that of water. And/or, the swinging element 03 is provided with hollow end 0311. Of course, other restoration structures can also be used, which will not be listed one by one here.

In another way of forming the restoring force, the swinging element 03 is restored by a counterweight fixed below the swinging axis 044. Due to the counterweight fixed below the swinging axis 044, a center of gravity of the swinging element 03 is located below the swinging axis 044.

In yet another way of forming the restoring force, an elastic restoring element such as a torsion spring is provided between the swinging element 03 and the pool cleaner body 090. When the elastic restoring element is in a free state (without any force in the circumferential direction), the swinging element 03 is vertical. When the swinging element swings due to the rotational force of the stopping device 02, the restoring element is compressed or stretched in the circumferential direction to form an elastic restoring force. When the stopping device 02 detaches from the swinging element 03, due to the elastic restoring force, the swinging element 03 is restored.

In addition, when the pool cleaner is obstructed, the rotating element 01 drives the stopping device 02 to rotate so as to push the swinging element 03 to pre-swing an angle towards an obstructed side (a side where the obstacle is located). Thus, the swinging element 03 generates a displacement component in the vertical direction (vertical to the direction of a cleaning surface, i.e. vertical to the direction of a surface on which the pool cleaner moves, and the cleaning surface can be a pool bottom, a pool wall or the obstacle, etc.). This provides a condition for the advance (before abutment) interference in the vertical direction between the swinging element 03 and the stopping device 02, causing the swinging element 03 to detach from the stopping device 02. Therefore:

[symbol]

As the rotating element 01 rotates, another stopping device 02 abuts with the swinging element 03, ensuring interference and abutment when another stopping device 02 rotates to the swinging element 03. Alternatively,

[symbol]

As the rotating element 01 rotates, the stopping device 02 abuts with another swinging element 03, ensuring interference and abutment when the stopping device 02 rotates to another swinging element 03.

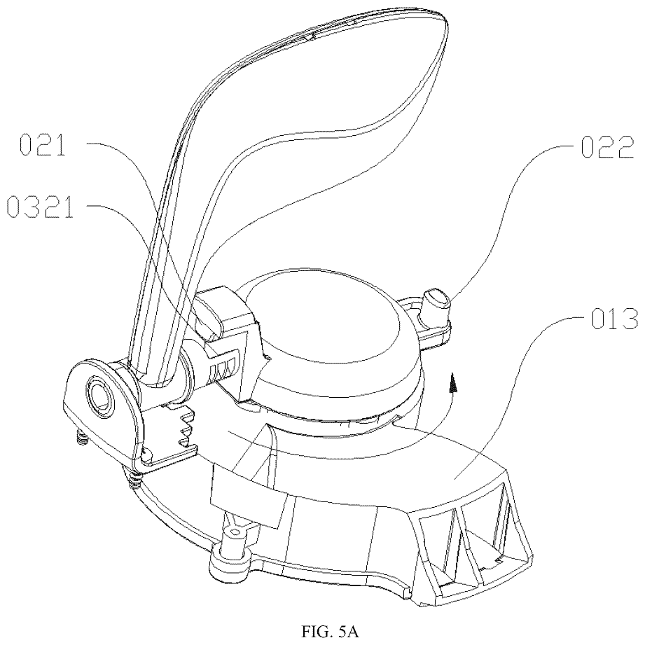

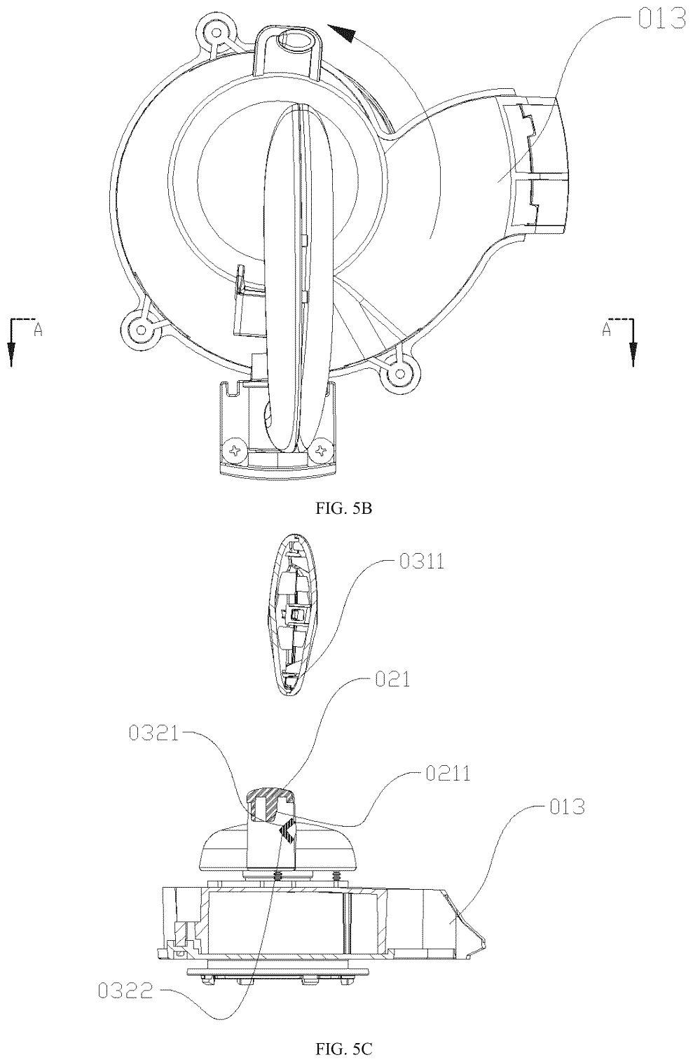

The rotating water outlet 013 points towards the second propelling direction 042. The design avoids the situation that during an initial state (shown in FIG. 5A, FIG. 5B, and FIG. 5C), the rotating element 01 continues to spin, causing the stopping device 02 fail to interfere and abut with the swinging element 03.

In the direction vertical to the cleaning surface, the swinging element 03 can be blocked by the stopping device 02. Structurally, the design allows the swinging element 03 to interfere with the rotation of the stopping device 02 (the rotating element 01) when it is restored.

Through the structural design, a rotational torque of the rotating element 01 is greater than a restoring torque of the swinging element 03. After the stopping device 02 is interfered by the swinging element 03, the rotating element 01 can overcome the blocking (due to the water resistance, a resistance caused by the restoring force, and a friction force caused by swinging, etc.) of the swinging element 03. A part of the swinging element 03 located above the swinging axis 044 swings towards the obstructed side, causing the stopping device to detach from the blocking of the swinging element. Meanwhile, a pre-swinging angle is formed to prepare for the next abutment between the stopping device 02 and the swinging element 03.

When the pool cleaner is obstructed, there are two stopping devices 02 in the case when the rotating element 01 rotates to the position where another stopping device 02 abuts with the swinging element 03. The two stopping devices 02 are symmetrically distributed on opposite sides of the rotation axis 043 and are fixed to the rotating element 01. Alternatively, the two stopping devices 02 are integrally formed.

When there are two stopping devices 02 and one swinging element 03, an angle between the swinging axis 044 and the first propelling direction 041 and an angle between the swinging axis 044 and the second propelling direction 042 are close to 90° (such as) 90°±45°. The swinging axis 044 is not parallel to the first propelling direction 041 and the second propelling direction 042 so as to ensure that the swinging element 03 swings due to the water resistance.

In a specific structure of the swinging element 03, the swinging element 03 extends radially along the swinging axis 044 to form swinging portion 031 and extends along the swinging axis 044 to form abutting assembly 032. The swinging portion 031 is located above the swinging axis 044, and the abutting assembly 032 is located on a side facing the stopping device 02. The abutting assembly 032 can abut with the stopping device 02. The swinging portion 031 is subjected to the water resistance. When the swinging portion takes buoyancy as the restoring force, the buoyancy of the swinging portion 031 is greater than its own gravity, allowing it to be restored. The abutting assembly 032 functions in interacting with the stopping device 02.

In a specific structure of the two stopping devices 02, the stopping device includes first stopping element 021 and second stopping element 022 that are arranged above and below. In the direction of the rotation axis, the first stopping element 021 and the second stopping element 022 maintain a clearance for the stopping device 02 to pass through, allowing the stopping device 02 and the swinging element 03 to freely pass through when they detach from each other.

In a specific structure of the abutting assembly 032, the abutting assembly is provided with first abutting portion 0321 abutting with the first stopping element 021 and second abutting portion 0322 abutting with the second stopping element 022.

When the pool cleaner is moving, the first abutting portion 0321 abuts with the first stopping element 021, and the second abutting portion 0322 abuts with the second stopping element 022. The rotating water outlet 013 is positioned in the first propelling direction 041 and the second propelling direction 042 through the abutment between the first stopping element 021 and the first abutting portion 0321 as well as the abutment between the second stopping element 022 and the second abutting portion 0322. The first stopping element 021 pushes the first abutting portion 0321, and the second stopping element 022 pushes the second abutting assembly, thereby achieving the above-mentioned pre-swinging an angle.

Regarding the settings of the first abutting portion 0321 and the first stopping element 021, the first abutting portion 0321 faces an opposite direction of the rotation direction 046 of the rotating element 01, and a side of the first stopping element 021 facing the rotation direction 046 of the rotating element 01 forms upper stopping surface 0211 that abuts with the first abutting portion 0321. The first abutting portion 0321 faces the upper stopping surface 0211 (the first abutting portion 0321 faces the opposite direction of the rotation direction of the rotating element 01, and the upper stopping surface 0211 faces the rotation direction of the rotating element 01). If the rotation direction 046 of the rotating element 01 driven by the water flow is a single direction, then the first abutting portion 0321 and the upper stopping surface 0211 are formed on one side (in the circumferential direction of the rotating element 01). If the rotation direction 046 of the rotating element 01 driven by the water flow is bidirectional, then the first abutting portion 0321 and the upper stopping surface 0211 are formed on two sides (in the circumferential direction of the rotating element 01). The design is applicable to a situation where the rotating element 01 is rotatable in two directions. Of course, as can be seen from the figure, it is easy to form the upper stopping surface 0211 on the two sides of the first stopping element 021. However, the size of the first abutting portion 0321 in a transverse direction is limited, so the first abutting portion 0321 cannot be directly formed on the two sides. In this case, it is necessary to appropriately increase the transverse (in the rotation direction 046 of the rotating element 01) size of the first abutting portion 0321. The improved structure is not shown in the figure.

In addition, the second abutting portion 0322 faces the opposite direction of the rotation direction 046 of the rotating element 01, and a side of the second stopping element 022 facing the rotation direction 046 of the rotating element 01 forms lower stopping surface 0221 that abuts with the second abutting portion. The first abutting portion 0321 and the lower stopping surface 0221 can be formed on a single or two sides. The structure and function of the second abutting portion and the second stopping element are the same as those of the first abutting portion 0321 and the first stopping element 021, and will not be repeated herein.

In addition, the first abutting portion 0321, the upper stopping surface 0211, the second abutting portion 0322, and the lower stopping surface 0221 are all flat. In the abutment state, the first abutting portion 0321 coincides with the upper stopping surface 0211, and the second abutting portion 0322 coincides with the lower stopping surface 0221, ensuring abutting stability. In the process of pre-swinging, the first stopping element 021 can slide along a slope direction of the upper stopping surface 0211, and the second stopping element 022 can slide along a slope direction of the lower stopping surface 0221, ensuring smooth pre-swinging.

It should also be noted that during restoration, an angle between the first abutting portion 0321 and a plane where traveling wheel 095 is located is equal to an angle between the second abutting portion 0322 and the plane where the traveling wheel 095 is located. The swinging portion 031 is vertical to the cleaning surface, and the first abutting portion 0321 and the second abutting portion 0322 are symmetrical about the cleaning surface. Through the symmetrical structure, the first stopping element 021 exerts a top-down effect on the swinging element 03, and the second stopping element 022 exerts a bottom-up effect on the swinging element 03, ensuring consistency between the abutting and pre-swinging actions and smooth operation.

It should also be noted that a free end of the swinging portion 031 is a flat structure that extends along a surface vertical to the moving direction. Through the flat structure of the free end, the swinging element 03 deflects due to the water resistance. The swinging element 03 is subjected to a great water resistance that maintains the same level at the rotational force of the rotating element 01, avoiding minor external factors (such as bumps) caused by an excessive deviation. The design avoids failure of abutment, pre-swinging, and detachment, ensuring reliable operation.

In the embodiment of the present disclosure, the mechanical direction change structure may further include top shell 06. The top shell 06 is located outside the rotating element 01 and forms diversion chamber 061. The top shell 06 is provided with water outlets 062 that are communicated with the diversion chamber 061. The water outlets 062 are respectively located in propelling directions pointed at by the rotating water outlet 013. The swinging axis 044 does not coincide with a connecting line between any water outlets 062, such that when the swinging element 03 is pushed forward in any propelling direction, it can swing due to the water resistance.

There are three or more water outlets 062. The traveling wheel 095 of the pool cleaner is a universal wheel. Correspondingly, the rotating water outlet 013 can also be positioned to a third propelling direction, . . . , and an N-th propelling direction. Through the universal wheel, the pool cleaner can be adjusted to a rolling state based on the positioning direction of the rotating water outlet 013, such that the pool cleaner can travel in no less than three directions.

This embodiment illustrates two water outlets 062 that are symmetrically arranged on two sides of the rotation axis. The two water outlets 062 correspond to the first propelling direction 041 and the second propelling direction 042 respectively, allowing the pool cleaner to travel in two directions.

The water outlet 062 extends in a direction vertical to the rotation axis. The reaction force of the water flowing out of the water outlet 062 passes through the rotation axis. A propelling force of the pool cleaner does not deviate from the rotation axis (center of the pool cleaner), avoiding problems such as weakened propelling force and uncertain moving direction caused by eccentric propelling, and ensuring propelling efficiency.

It should also be noted that the swinging axis 044 is parallel or approximately parallel to an axis of the traveling wheel 095 of the pool cleaner (the swinging axis 044 and the axis of the traveling wheel 095 can maintain a relatively small angle, such as 15°, to ensure smooth abutment, pre-swinging, and detachment). Therefore, under certain other conditions (relative speed of water and the fixed structure of the free end of the swinging portion 031), the swinging element 03 can swing due to a small water resistance, making it sensitive to changes in the water resistance. The design ensures the sensitivity and reliability of movement (the swinging portion 031 swings backwards in the moving state, is restored due to a reduced water resistance in the obstructed state, and swings after a direction change in the moving state).

In a mounting method of the stopping device 02, the top shell 06 is provided with a mounting hole, and the rotating element 01 passes through the mounting hole and is fixed to the stopping device 02. In order to achieve a small rotational resistance and a long lifespan of the rotating element 01, bearing 071 is provided in the mounting hole. The rotating element 01 and/or the stopping device 02 are rotatably provided on the top shell 06 through the bearing 071. Of course, in order to achieve convenience in mounting and disassembly, the rotating element 01 protrudes upwards through the mounting hole and is coaxially fixedly connected to the rotating element 07. The first stopping element 021 and the second stopping element 022 are respectively formed on the opposite sides of the rotation axis of the rotating element 07. The rotating element 07, the first stopping element 021, and the second stopping element 022 are integrally formed, for example, by injection molding.

The water flow is driven by power assembly 08. The power assembly 08 includes motor 081 and impeller 082 that are sequentially connected in a transmission manner. The impeller 082 is centrifugal impeller 082, and the impeller 082 is provided in the flow channel 012. An axis of the impeller 082 is coaxial with a direction of the water inlet 011 of the flow channel 012. The motor 081 is connected to a power supply (which can be a rechargeable battery provided on the pool cleaner body or a power supply provided outside the pool cleaner body 090) via a cable to drive the impeller 082 to rotate. The rotation of the impeller 082 causes the water to flow in the following order: outside of the rotating element 01, the water inlet 011, the flow channel 012, and the rotating water outlet 013. During the flow process, the rotating element 01 outside the flow channel 012 is driven to rotate by hydraulic coupling.

In addition, in order to facilitate the rotation of the rotating element 01 through the flow process of water, the rotating element 01 (the flow channel 012) is a snail shell structure.

Finally, in order to clearly and completely illustrate the direction change process of an embodiment of the mechanical direction change structure, FIG. 5A shows that the pool cleaner is stationary on the cleaning surface and the rotating element has not started to rotate, where the swinging element is in a restored state, and the stopping device detaches from the swinging element, allowing the rotating element to rotate freely; FIG. 5B is a top view of FIG. 5A; and FIG. 5C is a sectional view along A-A shown in FIG. 5B.

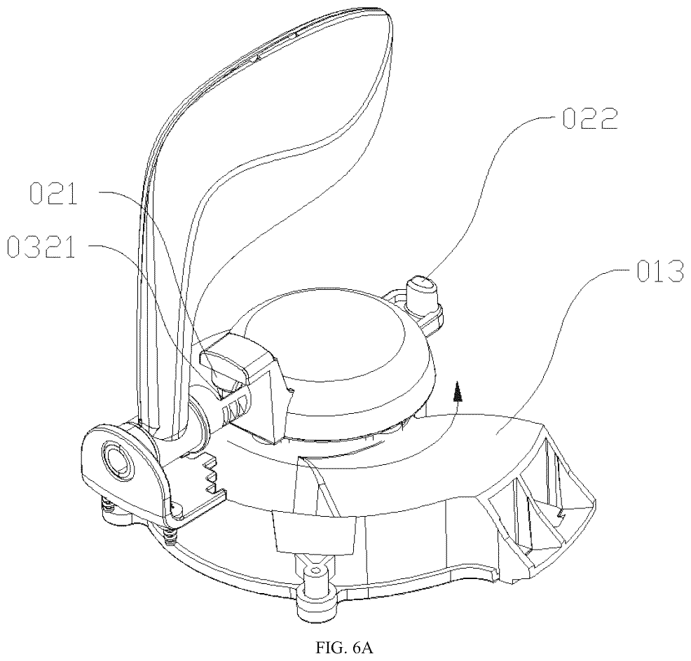

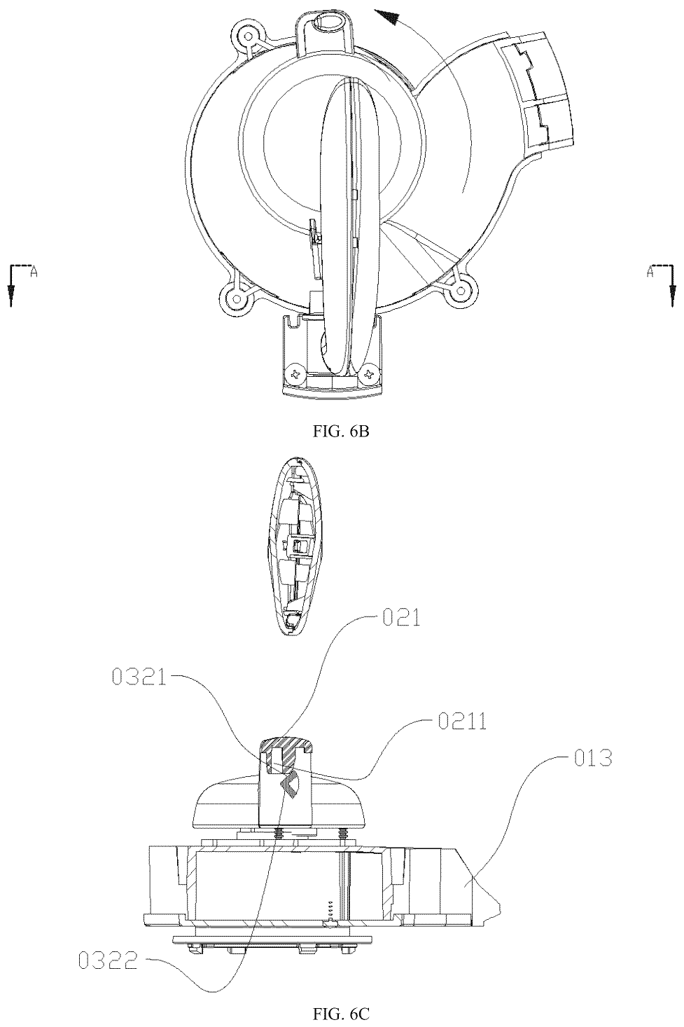

FIG. 6A shows that the rotating element rotates until the start of a pre-swinging (triggered by the first stopping element) action, where the swinging element is in the restored state; FIG. 6B is a top view of FIG. 6A; and FIG. 6C is a sectional view along A-A shown in FIG. 6B.

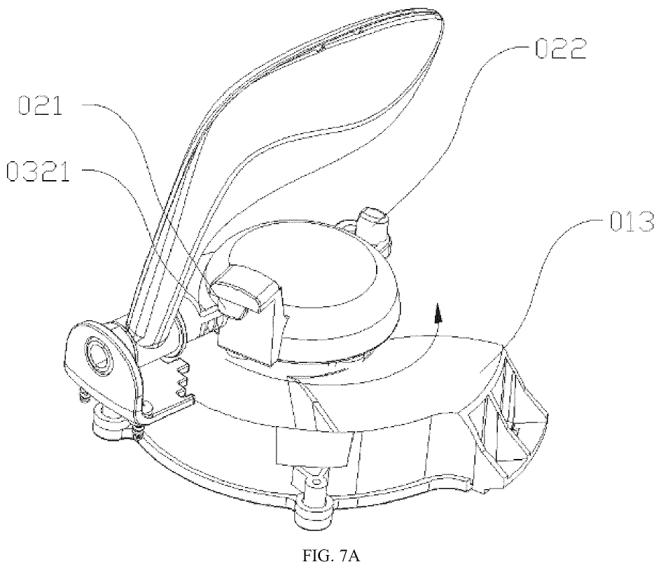

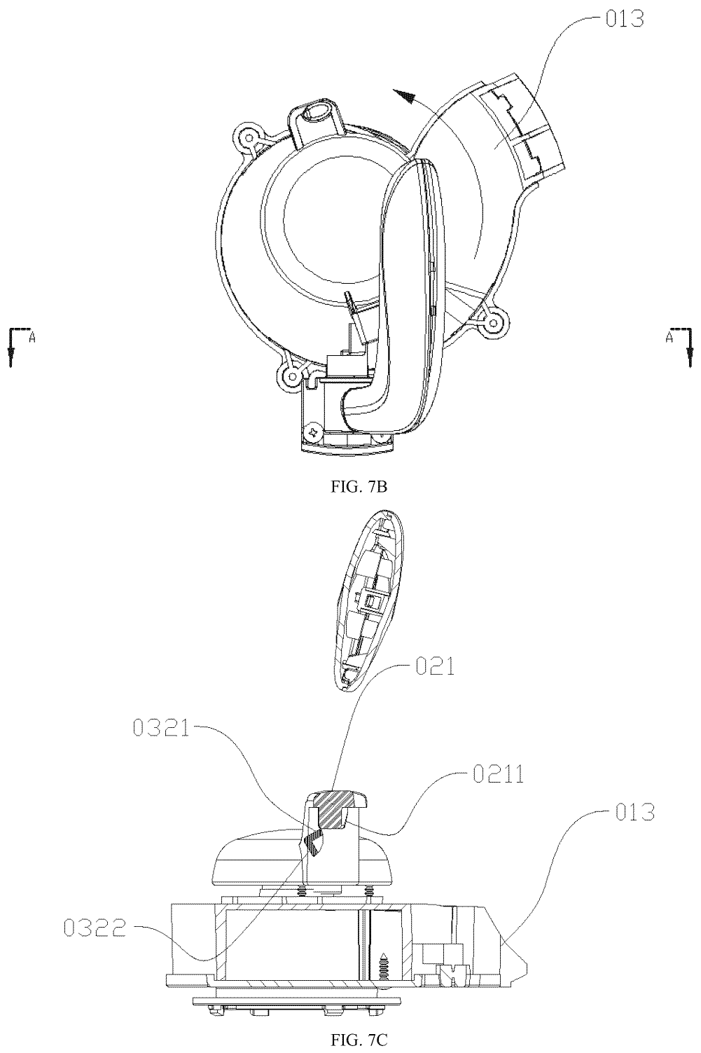

FIG. 7A shows that the rotating element rotates until the end of the pre-swinging (triggered by the first stopping element) action, where the pre-swinging action of the swinging element (in the rotation direction of the rotating element) an angle ends; FIG. 7B is a top view of FIG. 7A; and FIG. 7C is a sectional view along A-A shown in FIG. 7B.

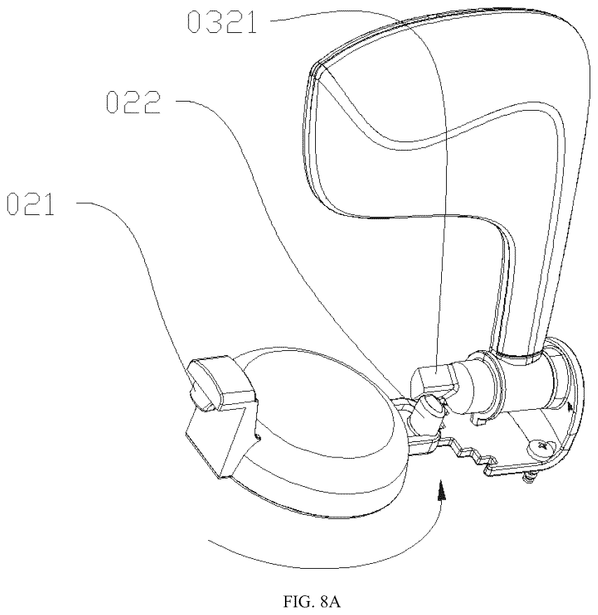

FIG. 8A shows that the rotating element rotates until the start of the abutment between the second stopping element and the swinging element, where the swinging element is restored a small angle from the pre-swinging angle shown in FIG. 7A; FIG. 8B is a top view of FIG. 8A; and FIG. 8C is a sectional view along A-A shown in FIG. 8B.

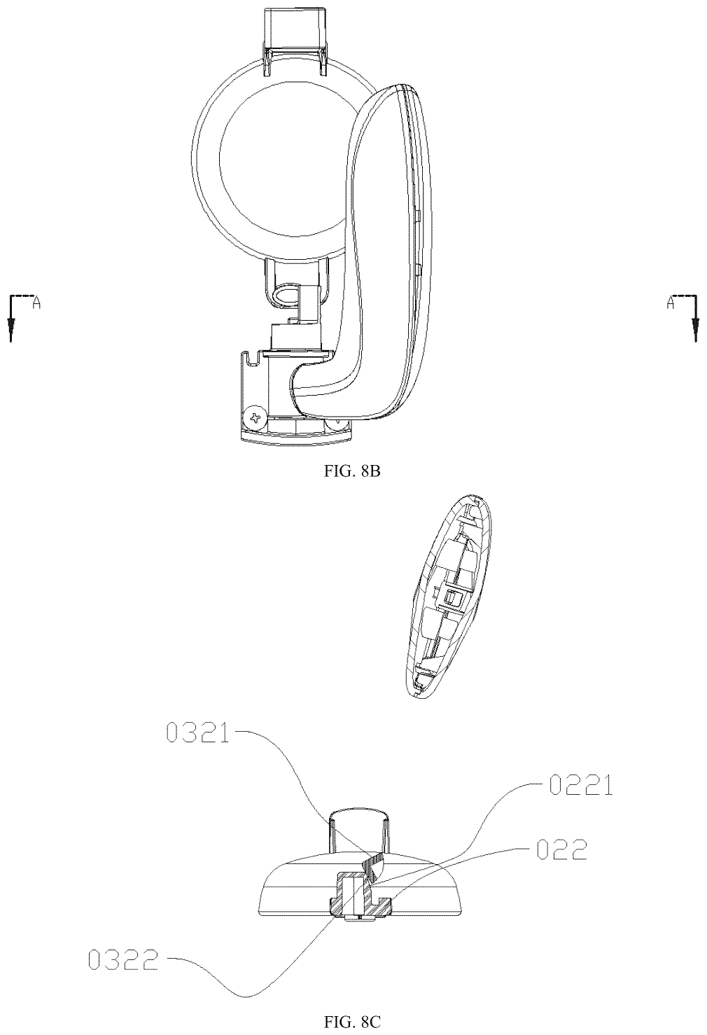

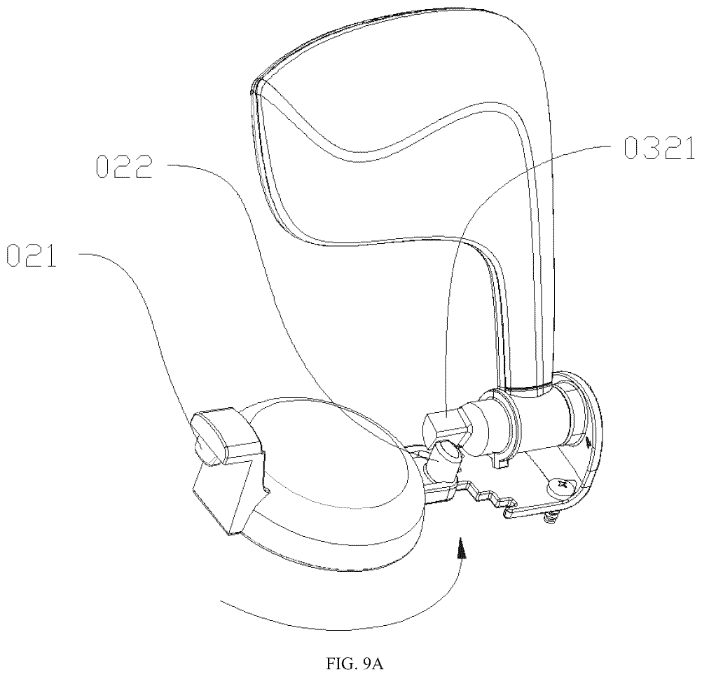

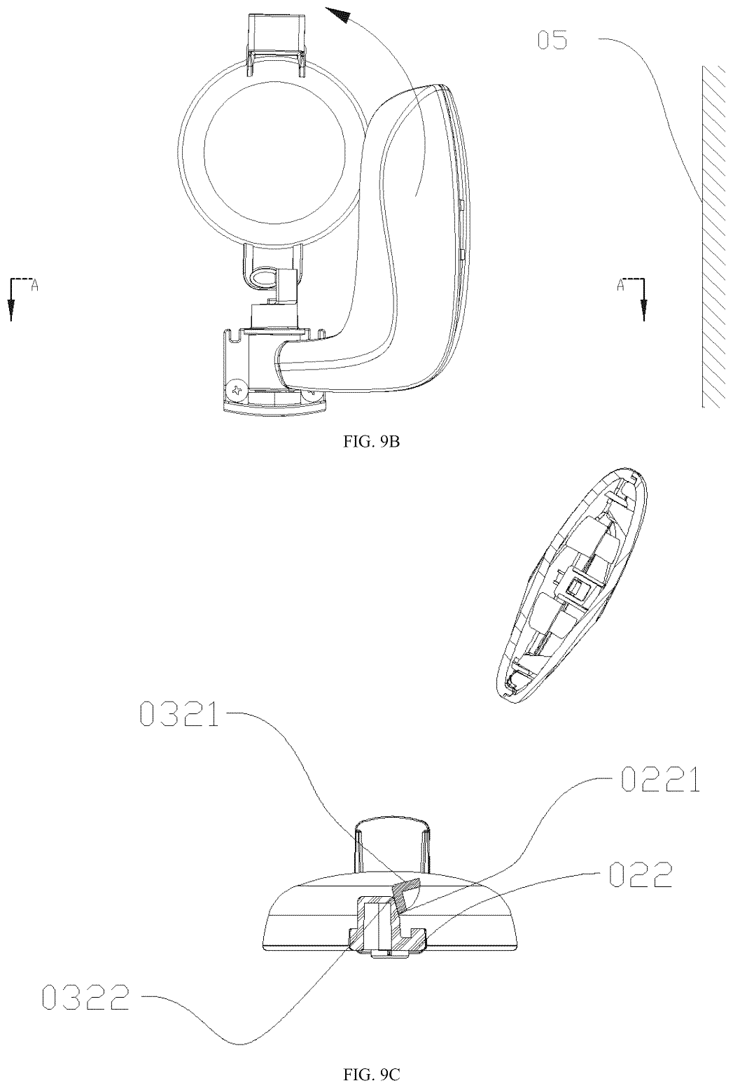

FIG. 9A shows that the rotating element rotates and the second stopping element abuts with the swinging element, the rotating water outlet is positioned in the first propelling direction, and the pool cleaner (generally) moves in the opposite direction of the first propelling direction; FIG. 9B is a top view of FIG. 9A; and FIG. 9C is a sectional view along A-A shown in FIG. 9B.

FIG. 10A shows that one side of the pool cleaner is obstructed, the swinging element is restored an angle to the restored state (not fully restored), the second stopping element detaches from the swinging element, and the swinging element pre-swings an angle due to the rotational force of the second stopping element; FIG. 10B is a top view of FIG. 10A; and FIG. 10C is a sectional view along A-A shown in FIG. 10B.

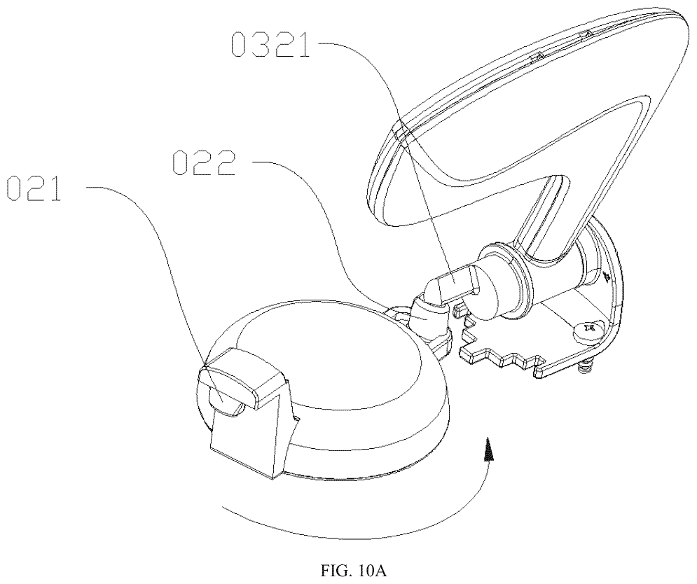

FIG. 11A shows that the second stopping element completely detaches from the swinging element, and the pre-swinging action of the swinging element caused by the second stopping element ends; FIG. 11B is a top view of FIG. 11A; and FIG. 11C is a sectional view along A-A shown in FIG. 11B.

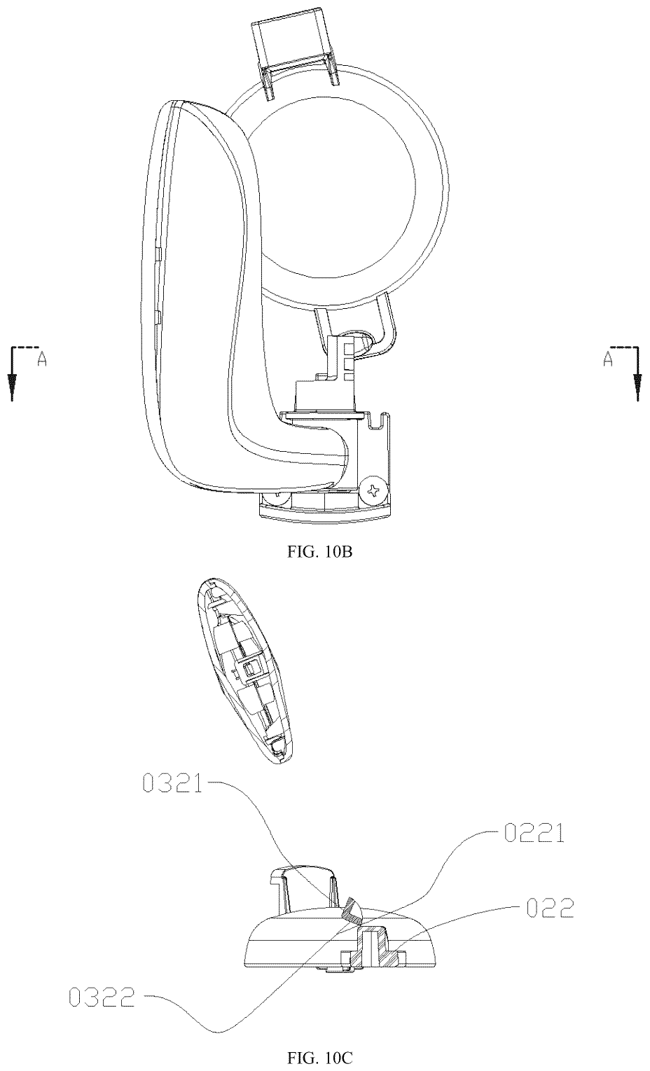

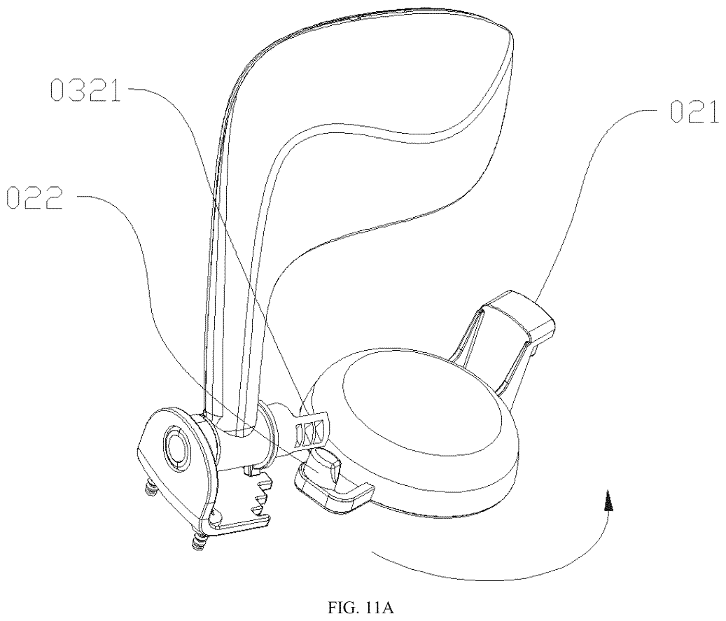

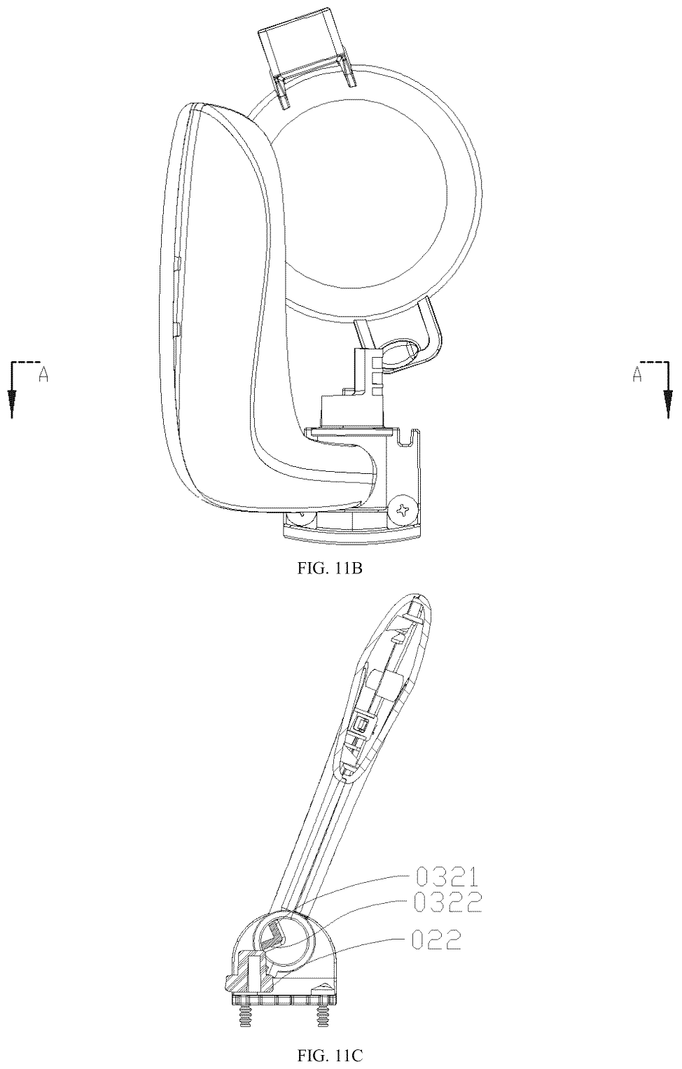

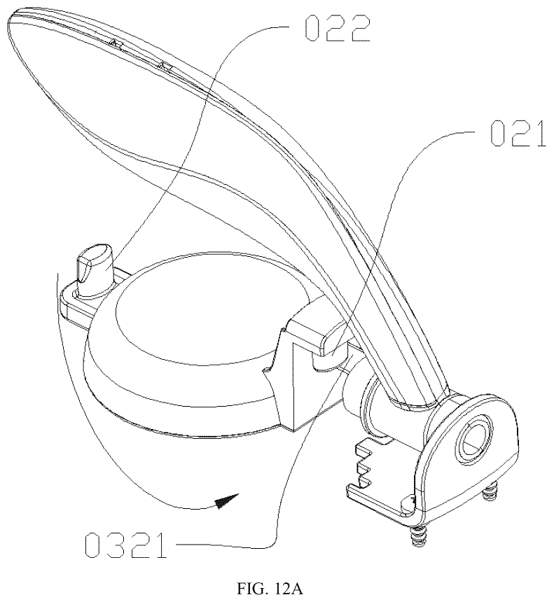

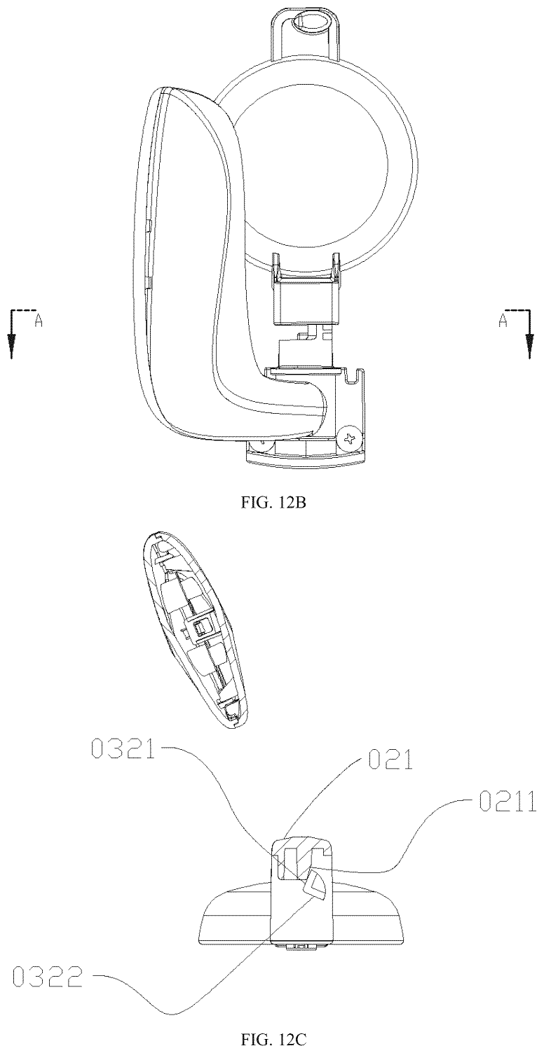

FIG. 12A shows that the first stopping element starts to abut with the swinging element; FIG. 12B is a top view of FIG. 12A; and FIG. 12C is a sectional view along A-A shown in FIG. 12B.

FIG. 13A shows that the first stopping element abuts with the swinging element, the rotating water outlet is positioned in the second propelling direction, and the pool cleaner (generally) moves in the opposite direction of the second propelling direction; FIG. 13B is a top view of FIG. 13A; and FIG. 13C is a sectional view along A-A shown in FIG. 13B.

A second aspect of the embodiment of the present disclosure provides a pool cleaner, including the mechanical direction change structure described in any one of the above paragraphs, and the following components that are sequentially communicated: main water inlet 091, main flow channel 092, main water outlet 093, filter structure 094, and the power assembly 08. The power assembly 08 causes the rotating element 01 to rotate and it is the power assembly 08 of the pool cleaner.

The main water outlet 093 is communicated with the water inlet. The power assembly 08 causes the water to flow sequentially along the main water inlet 091, the main flow channel 092, the main water outlet 093, the water inlet 011, the flow channel 012, and the rotating water outlet 013. The filter structure 094 is provided between the main flow channel 092 and the water inlet 011 to block and store a dirt in the water.

Finally, when the pool cleaner is obstructed, the pool cleaner comes to a standstill or decreases to a speed close to 0. The pool cleaner with the above mechanical cleaning structure is suitable for a direction change scenario where the pool cleaner is stationary in an obstructed state (the propelling force is less than an obstruction force exerted by the obstacle, such as when the obstacle is a pool wall, the large obstacle makes it impossible to propel the pool cleaner). It is also suitable for a direct change scenario where the pool cleaner decreases to a speed close to 0 in an obstructed state (the propelling force is greater than an initial resistance of the obstacle, the obstacle is propelled from a stationary state, the pool cleaner decelerates, and the swinging element 03 is restored).

A second way to drive the rotation of the rotating element 01 is magnetic coupling. The impeller 082 is provided with a first magnetic component, and the rotating element 01 is provided with a second magnetic component. The motor 081 drives the impeller 082 to rotate. Through the magnetic interaction between the first magnetic component and the second magnetic component, the impeller 082 drives the rotating element 01 to rotate. Of course, a combination of hydraulic coupling and magnetic coupling can also be used.

Embodiments of the present disclosure are described in detail above, but the contents are only preferred embodiments of the present disclosure and cannot be considered as limiting the scope of embodiments of the present disclosure. Any equivalent modifications, improvements, etc. made within the application scope of the present disclosure should fall within the protection scope of the present disclosure.

What is claimed is:

1. A mechanical direction change structure for a pool cleaner, comprising:
a rotating element, comprising a water inlet, a middle flow channel, and a rotating water outlet that are sequentially communicated for water to flow through, wherein the rotating element is rotatable around a rotation axis and provided on a pool cleaner body;
at least one stopping device, rotatable relative to the pool cleaner body; and
at least one swinging element, swingable around a swinging axis and provided on the pool cleaner body;
wherein, when the pool cleaner is moving, the at least one stopping device abuts with the at least one swinging element, and the rotating water outlet is positioned in a first propelling direction; and
when the pool cleaner is obstructed, the at least one stopping device detaches from the at least one swinging element, and the rotating water outlet rotates towards a second propelling direction

2. The mechanical direction change structure according to claim 1, wherein when the pool cleaner is obstructed,
the rotating element rotates to a position where another stopping device abuts with the swinging element; or
the rotating element rotates to a position where the stopping device abuts with another swinging element.

3. The mechanical direction change structure according to claim 1, wherein when the pool cleaner is obstructed, the stopping device is allowed to overcome the abutment with the swinging element, due to a rotational force of the rotating element.

4. The mechanical direction change structure according to claim 3, wherein the stopping device is fixed to the rotating element or formed on the rotating element.

5. The mechanical direction change structure according to claim 3, wherein in a stationary state underwater, the swinging element is allowed to be restored to remain vertical.

6. The mechanical direction change structure according to claim 5, wherein the swinging element is restored by a buoyancy.

7. The mechanical direction change structure according to claim 5, wherein the swinging element is restored by a counterweight fixed below the swinging axis.

8. The mechanical direction change structure according to claim 6, wherein
the swinging element is provided with an end with a density less than a density of water; and/or
the swinging element is provided with a hollow end.

9. The mechanical direction change structure according to claim 5, wherein an elastic restoring element is provided between the swinging element and the pool cleaner body.

10. The mechanical direction change structure according to claim 5, wherein when the pool cleaner is obstructed, the rotating element drives the stopping device to rotate, making the swinging element swing an angle towards an obstructed side and detach from the stopping device, wherein
as the rotating element rotates, another stopping device abuts with the swinging element, or
as the rotating element rotates, the stopping device abuts with another swinging element; and
the rotating water outlet points towards the second propelling direction.

11. The mechanical direction change structure according to claim 10, wherein the swinging element is allowed able to be blocked by the stopping device; and
a rotational torque of the rotating element is greater than a restoring torque of the swinging element, wherein the rotating element is allowed to overcome the blocking of the swinging element, causing a part of the swinging element located above the swinging axis to swing towards the obstructed side.

12. The mechanical direction change structure according to claim 11, wherein when the pool cleaner is obstructed, the rotating element rotates to a position where another stopping device abuts with the swinging element; and
there are two stopping devices; the two stopping devices are symmetrically distributed on opposite sides of the rotation axis and are fixed to the rotating element; or the two stopping devices are integrally formed.

13. The mechanical direction change structure according to claim 12, wherein there is one swinging element; and an angle between the swinging axis and the first propelling direction and an angle between the swinging axis and the second propelling direction are close to 90°.

14. The mechanical direction change structure according to claim 13, wherein the swinging element extends radially along the swinging axis to form a swinging portion and extends along the swinging axis to form an abutting assembly; the swinging portion is located above the swinging axis, and the abutting assembly is located on a side facing the stopping device; and the abutting assembly is allowed to abut with the stopping device.

15. The mechanical direction change structure according to claim 14, wherein the two stopping devices each comprise a first stopping element and a second stopping element that are arranged above and below; and the first stopping element and the second stopping element maintain a clearance in a direction of the rotation axis for the stopping device to pass through;
the abutting assembly is provided with a first abutting portion for abutting with the first stopping element and a second abutting portion for abutting with the second stopping element;
when the pool cleaner is moving, the first abutting portion abuts with the first stopping element; and
the second abutting portion abuts with the second stopping element.

16. The mechanical direction change structure according to claim 15, wherein the first abutting portion faces an opposite direction of a rotation direction of the rotating element, and a side of the first stopping element facing the rotation direction of the rotating element forms an upper stopping surface abutting with the first abutting portion.

17. The mechanical direction change structure according to claim 16, wherein the second abutting portion faces the opposite direction of the rotation direction of the rotating element, and a side of the second stopping element facing the rotation direction of the rotating element forms a lower stopping surface abutting with the second abutting portion.

18. The mechanical direction change structure according to claim 17, wherein the first abutting portion, the upper stopping surface, the second abutting portion, and the lower stopping surface are all flat.

19. The mechanical direction change structure according to claim 18, wherein during restoration, an angle between the first abutting portion and a plane where a traveling wheel is located is equal to an angle between the second abutting portion and the plane where the traveling wheel is located.

20. The mechanical direction change structure according to claim 14, wherein a free end of the swinging portion is a flat structure, the flat structure extends along a surface vertical to a moving direction.

21. The mechanical direction change structure according to claim 10, wherein the mechanical direction change structure further comprises a top shell; the top shell is located outside the rotating element and forms a diversion chamber; the top shell is provided with water outlets communicated with the diversion chamber; the water outlets are respectively located in propelling directions pointed at by the rotating water outlet; and the swinging axis does not coincide with a connecting line between any water outlets.

22. The mechanical direction change structure according to claim 21, wherein there are at least three water outlets; and a traveling wheel of the pool cleaner is a universal wheel.

23. The mechanical direction change structure according to claim 21, wherein there are two water outlets symmetrically arranged on two sides of the rotation axis.

24. The mechanical direction change structure according to claim 23, wherein the two water outlets extend in a direction vertical to the rotation axis.

25. The mechanical direction change structure according to claim 24, wherein the swinging axis is parallel or approximately parallel to an axis of a traveling wheel of the pool cleaner.

26. The mechanical direction change structure according to claim 21, wherein the top shell is provided with a mounting hole; and the rotating element passes through the mounting hole and is fixed to the stopping device.

27. The mechanical direction change structure according to claim 26, wherein a bearing is provided in the mounting hole; and the rotating element and/or the stopping device are rotatably provided on the top shell through the bearing.

28. The mechanical direction change structure according to claim 1, wherein the mechanical direction change structure further comprises a power assembly for causing the water to flow.

29. The mechanical direction change structure according to claim 28, wherein an impeller provided in the middle flow channel is a centrifugal impeller; and an axis of the impeller is coaxial with a direction of the water inlet of the middle flow channel.

30. The mechanical direction change structure according to claim 29, wherein the middle flow channel is a snail shell structure.

31. A pool cleaner, comprising:
the mechanical direction change structure according to claim 1;
a main water inlet, a main flow channel, and a main water outlet that are sequentially communicated, wherein the main water outlet is communicated with the water inlet;
a power assembly, configured to cause the water to flow sequentially along the main water inlet, the main flow channel, the main water outlet, the water inlet, the flow channel, and the rotating water outlet; and
a filter structure, provided between the main flow channel and the water inlet to block and store a dirt in the water.

32. The pool cleaner according to claim 31, wherein when the pool cleaner is obstructed, the pool cleaner comes to a standstill or decelerates to a speed close to 0.
